(19) United States
(12) Patent Application Publication
(10) Pub. No.: US 2009/0153027 A1
(43) Pub. Date: Jun. 18, 2009

(54) Warm-white semiconductor and its phosphor with red-spectrum garent structure

(76) Inventors: Soshchin Naum, Changhua City (TW); Wei-Hung Lo, Taipei City (TW); Chi-Ruei Tsai, Taipei City (TW)

Correspondence Address: The Weintraub Group, P.L.C., 28580 Orchard Lake Road, Suite 140, Farmington Hills, MI, 48334, US

(21) Appl. No.: 12/315,662

(22) Filed: Dec. 5, 2008

(30) Foreign Application Priority Data
Dec. 12, 2007 (TW) 096147524

(51) Int. Cl. H01J 1/62; C09K 11/78

(52) U.S. Cl. 313/503; 252/301.4 R

(57) ABSTRACT

The present invention discloses a warm-white semiconductor and its phosphor with red-spectrum garnet structure, comprising at least a semiconductor heterojunction and a light conversion film. The semiconductor heterojunction and light conversion film are characterized by that the warm-white luminescence is made up of three spectral bands which are related to the radiation of the activators, Ce, Pr, and Dy, in the inorganic phosphor of the light conversion film. The stoichiometric formula of the phosphor is (Y_{2-x-y-z-p}GdₓCe_{y}Pr_{z}DyₚO₃)_{1.5±α}(Al₂O₃)_{2.5±β}. The chromaticity coordinates of the light emitting diode are 0.405≦x≦0.515 and 0.355≦y≦0.550; color temperature T≦4000K; rendering index R≧80; and dominant wavelength λ≧565 nm.

### FIELD OF THE INVENTION

The present invention relates to the phosphor applied in warm-white light emitting diode, and in particular to a light emitting diode disposed with a light conversion film and the warm-light luminescence of the light emitting diode comprising three spectral bands, λ^{I}ₘₐₓ=450±25 nm, λ^{II}ₘₐₓ=560±20 nm, and λ^{III}ₘₐₓ=610±3 nm, in which the brightest red spectrum is related to the activator Pr⁺³ of which the degree of oxydation +3 in the phosphor.

### BACKGROUND OF THE INVENTION

If the development of the semiconductor electronics has been developing over 60 years, it has been only 10 years since the onset of the solid-state light source. Although the research works of Light Emitting Diode (LED) have been published since the sixties of the last century, the research of solid-state light source is best summarized by the book, Blue Laser (Springer Verlag, Berlin, 1997), authored by S. Nakamura.

The initial application of LED was used as signals and indicators, and was clearly illustrated in the book of Light Emitting Diode (V. Abramov et., USSR 1977). The first development stage of LED was established when it was made as a small-area radiator, which had relatively low light parameters. The LED at that time has the following characterizations: (1) the luminous intensity of viewing angle 2θ=30°, 100˜500 mcd (millicandelas); (2) low luminous flux, 0.1˜0.2 lm; and (3) average service life: 10⁴ hours.

With the creation of quantum-size devices, the light parameters of LED has been substantially enhanced to as followings. (1) The axial luminous intensity at 2θ=30° reaches 100 cd (candelas); (2) the luminous intensity reaches 5˜10 lm at a chip area of 100×200 μm² and the luminous intensity reaches 200˜300 lm at a chip area of 200×300 μm²; (3) average service life is extended to 10⁵ hours; and (4) its luminescent efficiency is 80˜100 lm/W.

Although the technical parameters of the semiconductor lighting elements have increased substantially, there are still problems demanded further attentions. First, the high quality light has to be ascertained by the rendering index (Ra≧95). The issue of light quality is important in the printing, textile, and jewelry industries, and the exhibition rooms of galleries and the conservation quarters for paintings. The second issue is related to the customary lighting environments experienced by human eyes. The lighting is usually associated with high-temperature white hot objects, carbon in oil wick and bonfire as well as red-hot tungsten filament in Edison light source. The luminous temperature of these objects is T≦4000K.

The first problem is related to color transmission, which may be resolved through a LED disposed with GaInN-based heterojunction (P-N junction), wherein the LED emits near ultraviolet and uses phosphors with three primary colors (RGB). On the other hand, the second problem may need many patents to improve. One of the patents needed was proposed by the LED framework comprising two-component luminescence (with reference to U.S. Pat. No. 5,988,925, Jul. 12, 1999 issued to S. Schimisu), wherein the heterojunction emits 450˜475 nm blue light and excites strong yellow photoluminescence from inorganic phosphor with a composition of (Y_{1-x-y}GdₓCe_{y})₃Al₅O₁₂. Two bright spectral bands of blue light (coming from heterojunction) and yellow light (coming from phosphor) conforms to the principle of complementary colors, leading to a white light.

In the initial LED structure (U.S. Pat. No. 5,988,925 issued to S. Schimisu issued, Jul. 12, 1999), a “cool white light” with color temperature T>10000K is guaranteed. The present invention has took reference from the device of the patent, but there are some substantive drawbacks: mainly including the radiation constituents of the standard phosphor (Y_{1-x-y}GdₓCe_{y})₃Al₅O₁₂ completely lacks of red light. After numerous experiments to enhance the red constituent in the radiation of the phosphor, the present inventors filed the patent application as the US Publication No. 2005/0088077 A1 (please refer to the US Patent application US 2005/0088077 A1 filed by N. Soshchin for details.). The proposed patent disclosed an ingredient of novel double activators for garnet phosphor; it comprises conventional activator Ce⁺³ and a second activator Pr⁺³ as well as accurate percentage of cationic elements yttrium and gadolinium. The high quality phosphor disclosed in the patent application can reduce the color temperature to T□5500K and shift the chromaticity coordinates to 0.32□x□0.36 and 0.32□y□0.37. The LED has been widely used because of its stable production technology and high light parameters.

Although LEDs have the advantages described, there are drawbacks remained unresolved. First, the high color temperature T□5500K will render human eyes prone to fatigued, reducing visual acuity. Second, conventional glowing heat source can easily lead to chromal distortion, compared to the color transmission of ordinary objects, flowers, fruits, and vegetables. These essential drawbacks demand our solution, yet provisional solutions rather definitive ones are usually adopted. For example, two-constituent phosphor filled with red-radiation (Ca,Sr)S:Eu is used to replace the single-constituent phosphor (Y_{1-x-y}GdₓCe_{y})₃Al₅O₁₂. The durability of the composite is low; it can only enable a LED to generate necessary warm-white light for a few thousand hours continuously. In the world with a substantial production of warm-white LED, many unsatisfactory solutions have been come up, yet virtually no world-class companies can overcome the technical difficulties so far.

Given the fact the blue light resulted from heterojunction and yellow or orange light resulted from LED experience a shift in balance, the luminescent efficiency sometimes reaches the minimum, which is exactly located in the calibrated temperature T□6000K. Since it is known that the η=90˜150 lm/W at T□6000K, it is essential to develop a LED with standard warm-white light to have a luminescent efficiency of η>80˜85 lm/W.

### SUMMARY OF THE INVENTION

To overcome the drawbacks of conventional arts, the primary objective of the present invention is to provide a warm-white semiconductor and its phosphor with red-spectrum garnet structure, which is technically significant for a warm-white LED with a color temperature T□4000K.

To overcome the drawbacks of conventional arts, another objective of the present invention is to provide a warm-white light semiconductor and its phosphor with red-spectrum garnet structure, whose radiations comprise clear orange-red colors to display suitable radiant chromaticity coordinates.

To overcome the drawbacks of conventional arts, yet another objective of the present invention is to provide a warm-white light semiconductor and its phosphor with red-spectrum garnet structure, which has a sufficient high luminescent efficiency.

To achieve the objectives described above, the present invention provides a warm-white semiconductor having a semiconductor heterojunction and a light conversion layer, characterized by that the warm-white luminescence is made up of three spectral bands which are related to the radiation of the activators, Ce, Pr, and Dy, in the inorganic phosphor of the light conversion film, and the stoichiometric formula of the phosphor is (Y_{2-x-y-z-p}GdₓCe_{y}Pr_{z}DyₚO₃)_{1.5±α}(Al₂O₃)_{2.5±β}.

To achieve the objectives described above, the present invention provides a phosphor with red-spectrum garnet structure, whose stoichiometric formula is (Y_{2-x-y-z-p}GdₓCe_{y}Pr_{z}DyₚO₃)_{1.5±α}(Al₂O₃)_{2.5±β}.

### BRIEF DESCRIPTION OF THE DRAWINGS

The present invention can be more fully understood by reference to the following description and accompanying drawings, in which:

FIG. 1 illustrates a warm-white semiconductor and its phosphor with red-spectrum garnet structure according to the present invention.

### DETAILED DESCRIPTION OF PREFERRED EMBODIMENT

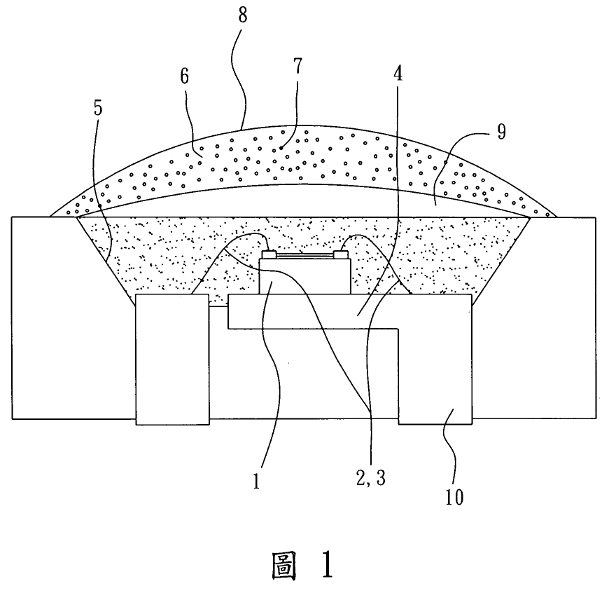

First, the objective of the present invention is to eliminate the aforementioned drawbacks described for the phosphor and warm-white Light Emitting Diode (LED). With reference to FIG. 1, the figure illustrates the warm-white LED with red-light spectrum according to the present invention. According to FIG. 1, the warm-white LED with red spectrum mark, comprising a semiconductor heterojunction 1, conducting wires 2 and 3, a heat-conducting base 4, a conical reflector 5, and a light conversion film 6;

wherein the semiconductor heterojunction 1 is disposed on the heat-conducting base 4, which is made of, for example but not limited to, Al₂O₃ sapphire, and disposed on the conical reflector 5;

wherein the semiconductor heterojunction 1 is in contact with the light conversion film 6 and the characteristics include the warm-white luminescence comprising three spectral bands, which are related to the radiation of the activators, Ce, Pr, and Dy, in the inorganic phosphor 7 of the light conversion film 6, and the stoichiometric formula of the phosphor is (Y_{2-x-y-z-p}GdₓCe_{y}Pr_{Z}DyₚO₃)_{1.5±α}(Al₂O₃)_{2.5±β};

wherein the indices of the stoichiometric indices of the phosphor 7 are 0.001□x□0.4, 0.01□y□0.2, 0.0001□z□0.1, 0.0001□p□0.1, 0.01□α□0.1, and 0.01□β□0.1;

wherein the three spectral bands are λ^{□}ₘₐₓ=450±25 nm, λ^{□}ₘₐₓ=560±20 nm, and λ^{□}ₘₐₓ=610±3 nm, respectively;

wherein the stoichiometric formula of the inorganic phosphor 7 is Y_{2.66}Gd_{0.32}Ce_{0.03}Pr_{0.005}Dy_{0.005}Al_{5.02}O_{12.06}, and the atomic fractions of the inorganic phosphor 7 is Ce/(Ce+Pr+Dy)□0.75 and Pr⁺³ forms the third emitted spectral band, suitable for ′D2-′C4 internal migration;

wherein the red spectral mark on the long wavelength of the main activator Ce⁺³ radiation of the inorganic phosphor 7 is related to the ′D2-′C4 internal migration of Pr⁺³ and the concentration of Pr⁺³ is 3˜25% of Ce⁺³; and

wherein the chromaticity coordinates of the LED is 0.405□x□0.515 and 0.355□y□0.550; color temperature T□4000K; rendering index R□80; and dominant wavelength λ□565 nm.

The In—Ga—N heterojunction 1 produces bright electroluminescence when the electrode of the warm-white LED according to the present invention provides a voltage of U=3.2˜3.4V and a current of I=20 mA. The light parameters associated with this phenomenon is shown in Annex 1. All the data were obtained from a spectroradiometer “Sensing.” The spectrum image of the experimental materials was obtained by scanning in the region 380˜800 nm. The image comprises two spectral bands, one of which has the largest wavelength λ=465 nm of the spectrum and is associated with the In—Ga—N heterojunction 1, and the other of which is a wide spectrum band and is related to the light conversion film in contact with the surface and side of the heterojunction.

The following descriptions will elucidate the necessary synthetic conditions for the high quality phosphor 7 for the warm-white LED. First, the present invention discloses that, in term of structure, the warm-white LED has included six basic type of chemical phosphor at the present time: (1) ZnS—ZnSe:Cu type of A^{□}B^{□} compound; (2) CaGa₂S₄:Eu type of A^{□}(Me^{□})₂(B^{□})₄ compound; (3) synthetic garnet (ΣLn)₃Al₅O₁₂; (4) phosphor with the stoichiometric formula Me₃Al₂(SiO₄)₃ of nature garnet; (5) Me(ΣLn) Al₇O₁₆ type of polyaluminate; and (6) metal silicate; and (7) polycation polymer N⁻³ or N⁻³₄.

For some silicates, sulfides, and garnets, they possess very high lumen equivalent of radiation. It is embodied in that the three aforementioned phosphors for LED display the least efficiency and the middle position is taken by the polymers based on N⁻³ or N⁻³₄. In this case, large Stoke's shift will lower the total efficiency. Since devices containing sulfides phosphor are usually not durable, a large amount of garnet phosphor and other varieties of silicate and polysilicate in industry. These phosphor have a substantive characteristic of high quantum efficiency; for silicate, η=70˜75%; for garnet phosphor, η=95%.

The main inorganic phosphor 7 disclosed in the present invention is based on synthetic garnet structure (ΣLU)₃Al₅O₁₂, wherein ΣLn=Y, Gd, Ce, Pr, and Dy, and this material was proposed by G. Blasse in the book, “Luminescent material (Refer to G. Blasse et and. Luminescent material. Springer Verlag, Berlin, 1994),” in which the material has been detailed and proposed as an effective radiator for electron diffractometer. The equipment has the advantage of a very large information block processing speed, 50 MHz (dark brown, used in satellite picturing). The phosphor Y₃Al₅O₁₂:Ce in natural radiators can guarantee a high information processing speed with the maximum spectrum λ=538 nm and afterglow time τₑ□120 ns. To increase the color saturation of the phosphor 7, it is necessary to add Gd⁺³, shifting the emitted spectrum to the yellow spectrum zone, and Lu⁺³ and/or Tb⁺³, shifting the emitted spectrum to the blue-yellow spectrum zone. There have been many similar materials proposed in industry before the Japanese LED researcher S. Schimisu; therefore, the priority of white LED addressed by white LED manufacturers and the “discovery” of synthetic garnet are baseless in law.

It has to point out that the phosphor 7 can adopt garnet with two different stoichiometric formula: (1) The first compound (ΣLn)₃Al₅O₁₂ proposed in the present invention, and (2) natural garnet has the stoichiometric formula as Me^{□}₃Me^{□}₂Si₄O₁₂. The present invention will clarify the property differences between these materials and the data are first shown in TABLE 1.

TABLE 1

| Parameters | (ΣLn)₃Al₅O₁₂ | Me^{□}₃Me^{□}₂Si₄O₁₂ |
|---|---|---|
| Number of atom in formula | 20 | 20 |
| Number of unit cell | 5 | 5 |
| Degree of oxidation (cation) | +3 | +2, +3 |
| Degree of oxidation (anion) | +3 | +4 |
| Crystal system | cube | cube |
| Spatial lattice | Ia3d | Ia3d |
| Lattice parameter | a□12A | a□12A |
| Exciting agents: Ce, Eu ions | Lower than 10²⁰ atoms | 10²¹ atoms |
| isomorphous capacity | | |
| Crystal morphology | Hexgonal- | Hexgonal- |
| | Dodecahedron | Dodecahedron |

As the comparisons described earlier, the two garnets with same structure and different chemical formulas have similar characteristics of crystal chemistry. The cations are characterized by that the elements in □_{A} group (Mg, Ca, Sr, for example) may be added into the “natural” chemical formula, yet elements with a degree of oxidation +3 may be added into the synthetic chemical formula. Similar anionic crystals are also different; Si⁺⁴ is dominated in the natural formula, while Al⁺³ (Ga⁺³ to a lesser extent) is more important in the synthetic formula. For natural garnet, its crystal parameter is characterized by that the decrease of isomorphism capacity is proportional to the concentration of activator (often Ce⁺³ or Eu⁺²). The defect will be manifested in the radiation because, with the decrease in the concentration of the activator, the radiation intensity of the phosphor 7 is reduced as a result.

Following the aforementioned arguments for the warm-white semiconductor, for example but not limited to warm-white light emitted diode according to the present invention, the synthetic phosphor 7 is preferably chosen as the raw materials. the phosphor 7 may include yttrium-gadolinium-aluminum garnet having multiple activators. The process of the synthesis employed in the present invention is from small to large or from nanometer to micrometer.

These synthetic processes and other conventional processes will be described in details. These processes are started with micrometer-size test reagent, which is synthesized by tens of micrometer powders and ground into a size of micrometer. The suitable synthetic process for the present invention first employs reagent of nanometer particles (d□50˜100 nm), which are subsequently processed to the size of d=1˜2 μm during heat treatment with technical medium. The transforming process from nanometer to micrometer proposed by the present invention has the advantage of eliminating the grinding procedure in conventional process. In addition to the aforementioned advantage, the present invention points out that the phosphor 7 is cubic crystal, mainly hexagonal-dodecahedron. Furthermore, the phosphor 7 according to the present invention is single crystal, a micro-crystal dominated structure. Since the phosphor 7 according to the present invention has the property of micro-single crystal, it possesses high light transmittance, which is clearly shown in Annex 2. The phosphor 7 according to the present invention cited here is obtained from a magnified photo (600 times) shown in a display screen. Since the deep blue excited light from the semiconductor heterojunction 1 with high light transmittance enters the phosphor 7 and actively interacts with the luminescent center, thereby inducing strong photoluminescence. The high light transmittance of the powder is responsible for the high radiant quantum efficiency, η=0.95.

The present invention also discloses another characteristic of the constituent of the phosphor 7 employed: the light conversion film 6 can be applied virtually without any constraint of concentration (5˜45% in mass). The concentration of most known products in the world is generally between 12˜16%. High concentration of ground phosphor 7 will not be able to acquire white light and the yellow light from radiation will dim and thus lose its luster. This is the main important technical feature of the phosphor used in the light conversion film 6 according to the present invention. The characteristic is that the aforementioned phosphor 7 of three-dimension light-transmittance particles has hexagonal-dodecahedron crystal, average size 1.5□d_{cp}□2.5 μm, and surface to volume ratio S_{yd}□36□10³ cm²/cm³. The data can guarantee that the mass concentration of the phosphor 7 in the light conversion film 6 is 5˜65% when the LED according to the present invention generates warm-white radiation. Consequently, the substantive characteristics of the warm-white light source according to the present invention includes the structure-parameter characteristics, the three-dimension morphology of the phosphor 7, which possesses very high light transmittance, and a wide range of concentration of the composite of polymer and the phosphor 7. The composite forms the matrix of the light conversion film 6 and interacts with InGaN heterojunction 1 of short-wavelength radiation.

It will now detail the composition of the phosphor 7 in the LED according to the present invention. As described earlier, the phosphor 7 is based on oxygen-containing garnet compound with rare earth elements and aluminum. Also, the rare earth elements involved comprise “light” group elements, Ce and Pr, as well as “heavy” group elements Gd, Y, and Dy. The garent phosphor 7 employed in the present invention has the following distinct characteristic: The chemical stoichiometric formula of the phosphor 7 can be controlled during the synthetic process, i.e., the ratio of the number of oxide molecules, more precisely, the ratio of the number of Σ(Lu₂O₃) molecules in forming cationic crystal to Al₂O₃ molecules in forming anionic crystal. For a conventional garent, the ratio ΣLu₂O₃/ΣAl₂O₃ is 3:5. For a garent compound suitable for the present invention, the first condition is that the ratio cannot be an integer and the second condition is the ratio can be varied, in which the fraction of cationic oxide is increased or the Al₂O₃ anionic oxide is increased as well as the “controllable chemical stoichiometry” according to the present invention is also included.

On the other hand, to increase the quantum efficiency of the phosphor 7 according to the present invention, the anionic oxide fraction should not exceed 5.0 units. According to the present invention, when the stoichiometric composition is ΣLu₂O₃/ΣAl₂O₃=3:5=0.6, the phosphor 7 prepared would have a quantum efficiency as η□0.89. The reasons behind the low efficiency are too many to list in the present invention. If the stoichiometric index β increases by 0.01 fraction, the radiant quantum efficiency of the phosphor 7 increases about 1%; If a constant value is kept, the stoichiometric index α=0. Furthermore, according to the present invention, the decrease of the stoichiometric index α will reduce the half bandwidth of the spectrum of the phosphor 7. If the stoichiometric composition has a half bandwidth λ_{0.5}=118 nm, the value will decrease by 0.5˜0.8 nm when the cation molar fraction decreases to α=0.005. The minimum extent of the reduction of the half bandwidth of the emitted spectral band is to λ_{0.5}=115 nm. Under this condition, however, the loss of the luminescent brightness of the phosphor 7 according to the present invention will become ΔL=2˜4%. Consequently, according to the preferred embodiment of the present invention, the stable stoichiometric index α is α□0.01. This result can be used to accurately calculate the second index β, whose increment cannot exceed 0.03 Mole fraction. From the stoichiometric formula of the fluorescent powder 7 according to the present invention, the stoichiometric formula of the garnet phosphor 7 is Y_{2.66}Gd_{0.32}Ce_{0.03}Pr_{0.005}Dy_{0.005}Al_{5.02}O_{12.06}. The largest wavelength of the spectrum of pure (Y, Ce)₃Al₅O₁₂ is λ=538 nm. According to the present invention, the addition of gadolinium ions can shift the maximum wavelength of the spectrum to λ=558 nm. The concentration of [Ce]=0.03 (atomic fraction) can shift the maximum spectrum by 2 nm to λ=560 nm. In the mean time, the first stage radiant energy of the semiconductor heterojunction 1 absorbed by the excited phosphor 7 can be enhanced. According to the present invention, the excessive Al₂O₃ in cationic crystal can enhance luminescent brightness and increase the Ce⁺³ radiant half bandwidth to a certain extent.

It has to point out the aim of the Dy⁺³ addition, which can increase the Ce⁺³ emitted spectrum and enhance the brightness to a certain extent (+2˜4%). However, according to the present invention, the main function of Dy⁺³ includes not only sensitizing of Ce⁺³, but also increasing the radiant efficiency of the second added activator, Pr⁺³. As described earlier in the present invention, the addition of Ce⁺³ and Pr⁺³ into the composition has generated beneficial effect and becomes the solution scheme of the present invention. However, the intensity of Pr⁺³ is not enhanced in any known combination, which is related to the internal migration ′D2-C4 within Pr⁺³. In (Y,Gd,Ce)₃Al₅O₁₂ garnet, the relevant peak value of Pr⁺³ on the long wavelength wing of the Ce⁺³ emitted spectrum is not large. The present invention for the first time points out that the radiant intensity of Pr⁺³ can enhance the signal to the maximum extent. This phenomenon has resulted in a unusual result, including the phosphor 7 with the composition of yttrium-gadolinium-aluminum garnet has a maximum spectrum value of λ=609.7 nm. This spectrum (with reference to Annex 3) has never been observed before the disclosure of the present invention. Due to the luminescent intensity of Pr⁺³, the emitted spectrum of the phosphor 7 with λ=575 nm has experienced a substantive shift in its “center of gravity.” Such a high dominant value has never been observed in the radiation of garent before. The enhanced fraction of red radiation and its result obtained with Pr⁺³ in the combination of Ce⁺³ and Dy⁺³ has reduced the color temperature in the present invention to T□4000K.

The advantages of the present invention can be embodied in its phosphor 7 with garnet crystal structure, which is characterized by that the stoichiometric formula as Y_{2.66}Gd_{0.32}Ce_{0.03}Pr_{0.005}Dy_{0.005}Al_{5.02}O_{12.06} with the atom ratio of t Ce/(Ce+Pr+Dy)>0.75. Also, the strong third spectral band formed by the radiation of Pr⁺³ is conducive to its internal electrons migration. As described earlier, the spectrum observed in the present invention is unusual and has not been mentioned in the aforementioned patents and technology literature. The increase of the maximum spectrum of Pr⁺³ is the result of the interaction of a series of elements: for example, the addition of Dy⁺³, and the sensitization of Ce⁺³ and Pr⁺³, and the stoichiometric composition of the phosphor 7 crystal with excessive Al₂O₃ anion. Also, the main emitted spectrum of the phosphor 7 becomes narrow. The interaction of all the elements of the phosphor 7 according to the present invention has led to a bright red spectral mark. The material was analyzed using spectroradiometer and the results are shown in Annex 3.

The substantive advantages of the phosphor 7 with garnet structure according to the present invention is characterized in that the bright spectrum mark is located at the Ce⁺³ long wavelength radiation and is related to the electron radiation at inner orbits of the ′D2-′C4 internal migration in Pr⁺³, wherein the concentration of Pr⁺³ is 3˜25% of Ce⁺³. Consequently, the LED and its light conversion film 6 according to the present invention have resolved important scientific and technical problems. The present invention provides stable and high efficient warm-white LED, whose light parameters show high brightness and luminous flux.

In short, the warm-white LED containing phosphor with red-spectrum garnet structure according to the present invention has a technological significance, which has the following advantages: color temperature T□4000K, its radiation comprising clear orange-red color, capable of exhibiting suitable radiant chromaticity coordinates, and having sufficient high luminescent efficiency. Consequently, the warm-white LED according to the present invention can indeed overcome the drawbacks of conventional warm-white LED.

It is appreciated that although the directional practice device of the present invention is used in a very limited space instead of practicing at the real playing field, effective and steady practice can be obtained as well. Further, it is very easy to set up and to operate the directional practice device of the present invention. These advantages are not possible to achieve with the prior art.

While the invention has been described with reference to the a preferred embodiment thereof, it is to be understood that modifications or variations may be easily made without departing from the spirit of this invention, which is defined by the appended claims.

What is claimed is:

1. A warm-white semiconductor, comprising a semiconductor heterojunction and a light conversion layer, characterized by that the warm-white luminescence is made up of three spectral bands which are related to the radiation of the activators, Ce, Pr, and Dy, in the inorganic phosphor of the light conversion film, and the stoichiometric formula of the phosphor is (Y_{2-x-y-z-p}GdₓCe_{y}Pr_{z}DyₚO₃)_{1.5±α}(Al₂O₃)_{2.5±β}.

2. The warm-white semiconductor as claimed in claim 1, wherein the phosphor may be with red-spectrum garnet structure, whose stoichiometric indices are 0.001≦x≦0.4, 0.01≦y≦0.2, 0.0001≦z≦0.1, 0.0001≦p≦0.1, 0.01≦α≦0.1, and 0.01≦β≦0.1.

3. The warm-white semiconductor as claimed in claim 1, wherein the three spectral bands are λ^{I}ₘₐₓ=450±25 nm, λ^{II}ₘₐₓ=560±20 nm, and λ^{III}ₘₐₓ=610±3 nm, respectively.

4. The warm-white semiconductor as claimed in claim 1, wherein the stoichiometric formula of the inorganic phosphor is Y_{2.66}Gd_{0.32}Ce_{0.03}Pr_{0.005}Dy_{0.005}Al_{5.02}O_{12.06}, and the atomic fractions of the inorganic phosphor is Ce/(Ce+Pr+Dy)≧0.75 and Pr⁺³ forms the third emitted spectral band, suitable for ′D2-′C4 internal migration.

5. The warm-white semiconductor as claimed in claim 1, wherein the red spectral mark on the long wavelength of the main activator Ce⁺³ radiation of the inorganic phosphor is related to the ′D2-′C4 internal migration of Pr⁺³ and the concentration of Pr⁺³ is 3˜25% of Ce⁺³.

6. The warm-white semiconductor as claimed in claim 1, wherein the chromaticity coordinates of the light-emitting diode are 0.405≦x≦0.515 and 0.355≦y≦0.550; color temperature T≦4000K; rendering index R≧80; and dominant wavelength λ≧565 nm.

7. A phosphor with red-spectrum garnet structure employed in warm-white light emitting diode having a stoichiometric formula of (Y_{2-x-y-z-p}GdₓCe_{y}Pr_{z}DyₚO₃)_{1.5±α}(Al₂O₃)_{2.5±β}.

8. The phosphor as claimed in claim 7, wherein the stoichiometric indices of the phosphor are 0.001≦x≦0.4, 0.01≦y≦0.2, 0.0001≦z≦0.1, 0.0001≦p≦0.1, 0.01≦α≦0.1, and 0.01≦β≦0.1.

9. The phosphor as claimed in claim 7, wherein the three spectral bands are λ^{I}ₘₐₓ=450±25 nm, λ^{II}ₘₐₓ=560±20 nm, and λ^{III}ₘₐₓ=610±3 nm, respectively.

10. The phosphor as claimed in claim 7, wherein the stoichiometric formula of the inorganic phosphor is Y_{2.66}Gd_{0.32}Ce_{0.03}Pr_{0.005}Dy_{0.005}Al_{5.02}O_{12.06}, and the a fractions of the phosphor is Ce/(Ce+Pr+Dy)≧0.75 and Pr⁺³ forms the third emitted spectral band, suitable for ′D2-′C4 internal migration.

11. The phosphor as claimed in claim 7, wherein the red spectral mark on the long wavelength of the main activator Ce⁺³ radiation of the inorganic phosphor is related to the ′D2-′C4 internal migration of Pr⁺³ and the concentration of Pr⁺³ is 3˜25% of Ce⁺³.
